(19) United States
(12) Patent Application Publication
(10) Pub. No.: US 2024/0304022 A1
(43) Pub. Date: Sep. 12, 2024

(54) PHYSIQUE DETERMINATION DEVICE AND PHYSIQUE DETERMINATION METHOD

(71) Applicant: Mitsubishi Electric Corporation, Tokyo (JP)

(72) Inventor: Naoya BABA, Tokyo (JP)

(73) Assignee: Mitsubishi Electric Corporation, Tokyo (JP)

(21) Appl. No.: 18/272,908

(22) PCT Filed: Feb. 25, 2021
(86) PCT No.: PCT/JP2021/006967

§ 371 Date: Jul. 18, 2023

(51) Int. Cl. G06V 40/10; B60R 21/015

(52) U.S. Cl. CPC G06V 40/103; B60R 21/01552

(57) ABSTRACT

There are provided processing circuitry configured to detect at least one skeleton coordinate point of an occupant indicating a body part of the occupant on a basis of a captured image obtained by capturing the occupant of a vehicle using an image capturing device; select, in a case where the detected skeleton coordinate points of the occupant indicate paired body parts, a physique determining skeleton coordinate point from the detected skeleton coordinate points of the occupant by using the at least one skeleton coordinate point closer to the image capturing device; at least one physique determining feature amount on a basis of information of the selected physique determining skeleton coordinate point and determine a physique of the occupant on a basis of the at least one physique determining feature amount having been calculated.

### TECHNICAL FIELD

The present disclosure relates to a physique determination device and a physique determination method for an occupant.

### BACKGROUND ART

Conventionally, there has been known a technique of determining the physique of an occupant of a vehicle in order to control an airbag, control a seat belt, detect an infant left in the vehicle, or the like in the vehicle.

For example, Patent Literature 1 discloses an occupant detection device that sets the shoulders and waists of an occupant as the trunk of the occupant, calculates the volume of the trunk of the occupant on the basis of a trunk surface indicating the trunk of the occupant as a surface, and determines the physique of the occupant on the basis of the calculated volume of the trunk of the occupant. The occupant detection device specifies the trunk surface of the occupant on the basis of the positions of joint points of the shoulders and the waists of the occupant estimated by analyzing captured images.

### CITATION LIST

### Patent Literatures

Patent Literature 1: JP 2018-96946 A

### SUMMARY OF INVENTION

### Technical Problem

In the conventional technique disclosed in Patent Literature 1, depending on the installation position of an image capturing device, the infrared emission range in a case where the image capturing device is an infrared camera, or the like, there is a case where the joint point of the shoulder of an occupant farther from the image capturing device or the joint point of the waist of the occupant farther from the image capturing device cannot be detected. In a case where any of the joint points of the shoulders of the occupant or any of the joint points of the waists of the occupant cannot be detected, the trunk surface of the occupant cannot be specified in the conventional technique. That is, the conventional technique has a problem that the physique of the occupant may not be determined because any of the joint points of the shoulders of the occupant or any of the joint points of the waists of the occupant cannot be detected.

The present disclosure has been made to solve the above problems, and an object of the present disclosure is to provide a physique determination device that improves the accuracy of physique determination as compared with a conventional technique in which physique determination is performed by detecting joint points of the shoulders and the waists of an occupant.

### Solution to Problem

A physique determination device according to the present disclosure including a skeleton detection unit to detect a skeleton coordinate point of an occupant indicating a body part of the occupant on a basis of a captured image obtained by capturing the occupant of a vehicle using an image capturing device, a skeleton-point selection unit to, in a case where skeleton coordinate points of the occupant detected by the skeleton detection unit indicate paired body parts, select a physique determining skeleton coordinate point from the skeleton coordinate points of the occupant detected by the skeleton detection unit by using the skeleton coordinate point closer to the image capturing device; a feature-amount calculation unit to calculate a physique determining feature amount on a basis of information of the physique determining skeleton coordinate point selected by the skeleton-point selection unit; and a physique determination unit to determine a physique of the occupant on a basis of the physique determining feature amount calculated by the feature-amount calculation unit.

### Advantageous Effects of Invention

According to the present disclosure, the physique determination device can improve the accuracy of physique determination as compared with a conventional technique in which physique determination is performed by detecting joint points of the shoulders and the waists of the occupant.

### BRIEF DESCRIPTION OF DRAWINGS

FIG. 1 is a diagram illustrating a configuration example of a physique determination device according to a first embodiment.

FIG. 2 is a diagram for explaining an image of joint points defined in the first embodiment.

FIG. 3 is a diagram for explaining an example of skeleton coordinate points detected by a skeleton detection unit in the first embodiment.

FIG. 4 is a flowchart for explaining an operation of the physique determination device according to the first embodiment.

FIGS. 5A and 5B are diagrams for explaining an example of a captured image in a case where a skeleton coordinate point farther from an image capturing device is not detected.

FIGS. 6A and 6B are diagrams illustrating an example of a hardware configuration of the physique determination device according to the first embodiment.

### DESCRIPTION OF EMBODIMENTS

Hereinafter, embodiments of the present disclosure will be described in detail with reference to the drawings.

### First Embodiment

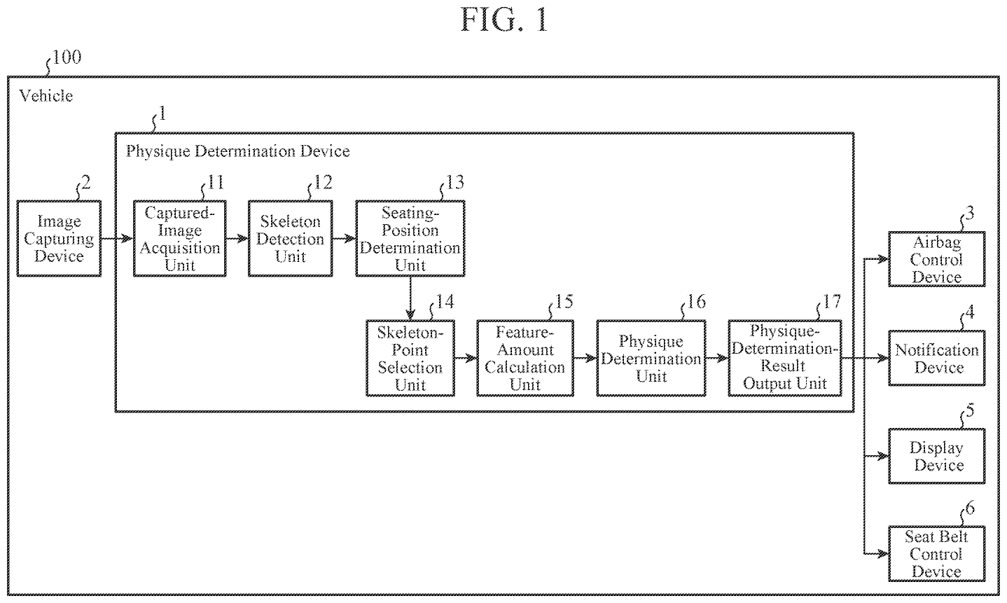

FIG. 1 is a diagram illustrating a configuration example of a physique determination device 1 according to a first embodiment.

In the first embodiment, the physique determination device 1 is assumed to be mounted on a vehicle 100.

The physique determination device 1 is connected to an image capturing device 2, an airbag control device 3, a notification device 4, a display device 5, and a seat belt control device 6. The image capturing device 2, the airbag control device 3, the notification device 4, the display device 5, and the seat belt control device 6 are mounted on the vehicle 100.

The image capturing device 2 is, for example, a near-infrared camera or a visible light camera, and captures occupants of the vehicle 100. For example, the image capturing device 2 may be shared with an image capturing device included in a so-called “driver monitoring system” mounted on the vehicle for monitoring the state of a driver in the vehicle 100.

The image capturing device 2 is installed to be able to capture at least a range in the vehicle 100 including a range in which the upper body of the occupant of the vehicle 100 is to be present. The range in which the upper body of the occupant in the vehicle 100 is to be present is, for example, a range corresponding to the space near the front of a backrest and a headrest of a seat.

In the first embodiment, as an example, it is assumed that the image capturing device 2 is installed at the center of an instrument panel (hereinafter, referred to as “instrument panel”) of the vehicle, and captures front seats including a driver seat and a passenger seat from the center of the instrument panel. That is, in the first embodiment, the image capturing device 2 captures the driver and the occupant in the passenger seat (hereinafter, referred to as “passenger seat occupant”) from the center of the instrument panel.

The physique determination device 1 determines the physique of the occupant of the vehicle 100 on the basis of a captured image obtained by capturing the occupant of the vehicle 100 using the image capturing device 2. In the first embodiment, the occupants of the vehicle 100 include a driver and a passenger seat occupant. That is, in the first embodiment, the physique determination device 1 determines the physiques of the driver and the passenger seat occupant on the basis of a captured image obtained by capturing the driver and the passenger seat occupant using the image capturing device 2.

In the first embodiment, the physique determined by the physique determination device 1 is assumed to be any of “infant”, “small”, “standard”, and “large”. Note that this is merely an example, and the definition of the physique determined by the physique determination device 1 can be appropriately set.

When determining the physique of the occupant of the vehicle 100, the physique determination device 1 outputs a result of determining the physique of the occupant of the vehicle 100 (hereinafter, referred to as “physique determination result”) to the airbag control device 3, the notification device 4, the display device 5, and the seat belt control device 6.

Details of the physique determination device 1 will be described later.

The airbag control device 3 is an engine control unit (ECU) for an airbag system, and controls an airbag on the basis of the physique determination result output from the physique determination device 1.

The notification device 4 is, for example, a seat belt reminder, and outputs an alarm in consideration of the physique of the occupant on the basis of the physique determination result output from the physique determination device 1.

The display device 5 is provided, for example, in a center cluster or a meter panel, and performs display based on the physique determination result output from the physique determination device 1. For example, in a case where there is an “infant” among the occupants, the display device 5 displays an icon indicating that a child is in the vehicle.

The seat belt control device 6 adjusts the restraint force of the seat belt depending on the physique of the occupant on the basis of the physique determination result output from the physique determination device 1.

The physique determination device 1 includes a captured-image acquisition unit 11, a skeleton detection unit 12, a seating-position determination unit 13, a skeleton-point selection unit 14, a feature-amount calculation unit 15, a physique determination unit 16, and a physique-determination-result output unit 17.

The captured-image acquisition unit 11 acquires a captured image obtained by capturing an occupant of the vehicle using the image capturing device 2.

The captured-image acquisition unit 11 outputs the acquired captured image to the skeleton detection unit 12.

Note that the physique determination device 1 does not need to include the captured-image acquisition unit 11, and the skeleton detection unit 12 to be described later may have the function of the captured-image acquisition unit 11.

The skeleton detection unit 12 detects skeleton coordinate points of the occupant indicating body parts of the occupant on the basis of the captured image acquired by the captured-image acquisition unit 11. More specifically, the skeleton detection unit 12 detects skeleton coordinate points of the occupant indicating joint points determined for the individual body parts of the occupant on the basis of the captured image acquired by the captured-image acquisition unit 11.

Specifically, the skeleton detection unit 12 detects coordinates of a skeleton coordinate point of the occupant and detects which part of the body of the occupant the skeleton coordinate point indicates.

The skeleton coordinate point is, for example, a point in the captured image, and is represented by coordinates in the captured image.

Here, the definition of the joint points in the first embodiment will be described.

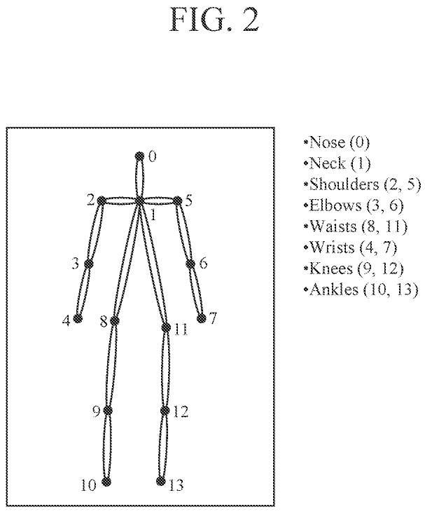

FIG. 2 is a diagram for explaining a concept of joint points defined in the first embodiment.

As illustrated in FIG. 2, in the first embodiment, as the joint points determined for the individual parts of the human body, a nose joint point (indicated by “0” in FIG. 2), a neck joint point (indicated by “1” in FIG. 2), shoulder joint points (indicated by “2” and “5” in FIG. 2), elbow joint points (indicated by “3” and “6” in FIG. 2), waist joint points (indicated by “8” and “11” in FIG. 2), wrist joint points (indicated by “4” and “7” in FIG. 2), knee joint points (indicated by “9” and “12” in FIG. 2), and ankle joint points (indicated by “10” and “13” in FIG. 2) are defined.

As illustrated in FIG. 2, for paired body parts, specifically, a shoulder, an elbow, a waist, a wrist, a knee, and an ankle, two left and right joint points are defined as joint points corresponding to the body parts.

The skeleton detection unit 12 detects the skeleton coordinate point of the occupant by obtaining information on the skeleton coordinate point of the occupant using, for example, a learned model in machine learning (hereinafter, referred to as “first machine learning model”).

The first machine learning model is a machine learning model that receives, as an input, a captured image obtained by capturing the occupant of the vehicle 100 and outputs information indicating a skeleton coordinate point in the captured image. The information indicating the skeleton coordinate point includes the coordinates of the skeleton coordinate point in the captured image and information capable of specifying which part of the body the skeleton coordinate point indicates.

The first machine learning model is constructed so as to estimate a result for an input in accordance with training data generated in advance on the basis of a combination of an input and teacher label data, that is, by so-called supervised learning. Here, the first machine learning model performs learning so as to output information of a skeleton coordinate point in a captured image in accordance with training data in which the input is the captured image, and the teacher label is the information of the skeleton coordinate point.

The first machine learning model is stored in advance in a place that can be referred to by the skeleton detection unit 12. Note that the first machine learning model performs learning so as to output information on a plurality of skeleton coordinate points in the captured image.

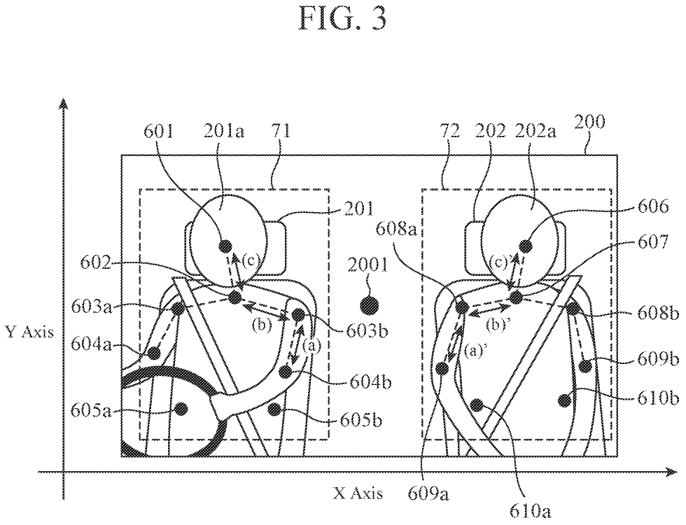

FIG. 3 is a diagram for explaining an example of skeleton coordinate points detected by the skeleton detection unit 12 in the first embodiment. Note that the vehicle 100 is a right-hand drive vehicle.

In the vehicle 100, it is assumed that the driver is seated on a driver seat and the passenger seat occupant is seated on a passenger seat. In this case, the image capturing device 2 captures the driver and the passenger seat occupant.

In FIG. 3, 200 denotes a captured image captured by the image capturing device 2, 201 denotes the driver seat, and 201a denotes the driver. Furthermore, in FIG. 3, 202 denotes the passenger seat, and 202a denotes the passenger seat occupant. Further, in FIG. 3, 2001 denotes an image capturing center in the captured image 200, in other words, the optical axis of the image capturing device 2.

In FIGS. 3, 601, 602, 603a, 603b, 604a, 604b, 605a, 605b, 606, 607, 608a, 608b, 609a, 609b, 610a, and 610b denote skeleton coordinate points in the captured image.
601 denotes a skeleton coordinate point indicating the nose of the driver 201a.
602 denotes a skeleton coordinate point indicating the neck of the driver 201a.
603a denotes a skeleton coordinate point indicating the right shoulder of the driver 201a.
603b denotes a skeleton coordinate point indicating the left shoulder of the driver 201a.
604a denotes a skeleton coordinate point indicating the right elbow of the driver 201a.
604b denotes a skeleton coordinate point indicating the left elbow of the driver 201a.
605a denotes a skeleton coordinate point indicating the right waist of the driver 201a.
605b denotes a skeleton coordinate point indicating the left waist of the driver 201a.
606 denotes a skeleton coordinate point indicating the nose of the passenger seat occupant 202a.
607 denotes a skeleton coordinate point indicating the neck of the passenger seat occupant 202a.
608a denotes a skeleton coordinate point indicating the right shoulder of the passenger seat occupant 202a.
608b denotes a skeleton coordinate point indicating the left shoulder of the passenger seat occupant 202a.
609a denotes a skeleton coordinate point indicating the right elbow of the passenger seat occupant 202a.
609b denotes a skeleton coordinate point indicating the left elbow of the passenger seat occupant 202a.
610a denotes a skeleton coordinate point indicating the right waist of the passenger seat occupant 202a.
610b denotes a skeleton coordinate point indicating the left waist of the passenger seat occupant 202a.

The skeleton detection unit 12 detects the skeleton coordinate points 601 to 610b. Although not illustrated for convenience, the skeleton detection unit 12 also detects a skeleton coordinate point indicating the left wrist of the driver 201a.

In the above description, for the sake of convenience, the skeleton coordinate points 601 to 610b are described in association with the driver 201a or the passenger seat occupant 202a, but the skeleton detection unit 12 cannot specify which occupant's skeleton coordinate point it is.

The skeleton detection unit 12 detects the coordinates of each of the skeleton coordinate points 601 to 610b in the captured image and detects which part of the body each of the skeleton coordinate points 601 to 610b indicates.

In FIG. 3, regions denoted by 71 and 72 and line segments denoted by (a) to (c) and (a)′ to (c)′ will be described later.

The skeleton detection unit 12 outputs information of the detected skeleton coordinate points to the seating-position determination unit 13.

The seating-position determination unit 13 determines the seating position of the occupant on the basis of the information of the skeleton coordinate points detected by the skeleton detection unit 12. In the first embodiment, the seating position of the occupant is represented by a seat on which the occupant is seated. Therefore, the seating-position determination unit 13 determines the seat on which the occupant is seated on the basis of the information of the skeleton coordinate points detected by the skeleton detection unit 12. Then, the seating-position determination unit 13 associates the information of the skeleton coordinate points of the occupant output from the skeleton detection unit 12 with the information of the seat on which the occupant is seated.

For example, in the captured image, the region corresponding to the seat (hereinafter, referred to as “seat corresponding region”) is set in advance for each seat. The seat corresponding region is set in advance on the basis of the installation position and the angle of view of the image capturing device 2.

First, the seating-position determination unit 13 determines the seat on which the occupant is seated on the basis of whether or not the skeleton coordinate points included in the seat corresponding region are present among the skeleton coordinate points detected by the skeleton detection unit 12. As a specific example, for example, in a case where there are skeleton coordinate points included in the seat corresponding region corresponding to the driver seat among the skeleton coordinate points detected by the skeleton detection unit 12, the seating-position determination unit 13 determines that the driver is seated on the driver seat. In addition, for example, in a case where there are skeleton coordinate points included in the seat corresponding region corresponding to the passenger seat among the skeleton coordinate points detected by the skeleton detection unit 12, the seating-position determination unit 13 determines that the passenger seat occupant is seated on the passenger seat.

For example, in FIG. 3, it is assumed that the seat corresponding region corresponding to the driver seat 201 is a region denoted by 71, and the seat-corresponding region corresponding to the passenger seat 202 is a region denoted by 72. In this case, in the example illustrated in FIG. 3, since there are skeleton coordinate points 601 to 605b included in the seat corresponding region 71, the seating-position determination unit 13 determines that the driver 201a is seated on the driver seat 201. That is, the seating-position determination unit 13 can determine that the skeleton coordinate points 601 to 605b are the skeleton coordinate points of the driver 201a. Furthermore, since there are skeleton coordinate points 606 to 610b included in the seat corresponding region 72, the seating-position determination unit 13 determines that the passenger seat occupant 202a is seated on the passenger seat 202. That is, the seating-position determination unit 13 can determine that the skeleton coordinate points 606 to 610b are the skeleton coordinate points of the passenger seat occupant 202a.

When determining the seat on which the occupant is seated, the seating-position determination unit 13 associates the information of the skeleton coordinate points detected by the skeleton detection unit 12 with the information of the seat on which the occupant is seated.

In the example of FIG. 3, the seating-position determination unit 13 associates the information of the skeleton coordinate points 601 to 605b with the information indicating the driver seat. In addition, the seating-position determination unit 13 associates the information of the skeleton coordinate points 606 to 610b with the information indicating the passenger seat.

Then, the seating-position determination unit 13 outputs information (hereinafter, referred to as “seat-associated skeleton-coordinate-point information”) in which the information of the skeleton coordinate points is associated with the information of the seat on which the occupant is seated to the skeleton-point selection unit 14.

The skeleton-point selection unit 14 selects skeleton coordinate points (hereinafter, referred to as “physique determining skeleton coordinate points”) to be used for determining the physique of the occupant from the skeleton coordinate points of the occupant detected by the skeleton detection unit 12 on the basis of the seat-associated skeleton-coordinate-point information output from the seating-position determination unit 13. At this time, in a case where the skeleton coordinate points of the occupant detected by the skeleton detection unit 12 are skeleton coordinate points indicating paired body parts, the skeleton-point selection unit 14 selects the physique determining skeleton coordinate points by using the skeleton coordinate points closer to the image capturing device 2.

Note that the skeleton-point selection unit 14 selects the physique determining skeleton coordinate points for each occupant.

For example, it is assumed that the skeleton detection unit 12 detects the skeleton coordinate points 601 to 610b of the occupants as illustrated in FIG. 3. In this case, the skeleton-point selection unit 14 selects the physique determining skeleton coordinate points of the driver 201a and the physique determining skeleton coordinate points of the passenger seat occupant 202a.

Here, the shoulder, the elbow, and the waist are skeleton coordinate points indicating paired body parts. Therefore, for the skeleton coordinate points 601 to 605b of driver 201a, the skeleton-point selection unit 14 selects, as the physique determining skeleton coordinate points of the driver 201a, the skeleton coordinate point 601 indicating the nose, the skeleton coordinate point 602 indicating the neck, the skeleton coordinate point 603b indicating the left shoulder, which is closer to the image capturing device 2, out of the skeleton coordinate points 603a and 603b indicating the shoulders, the skeleton coordinate point 604b indicating the left elbow, which is closer to the image capturing device 2, out of the skeleton coordinate points 604a and 604b indicating the elbows, and the skeleton coordinate point 605b indicating the left waist, which is closer to the image capturing device 2, out of the skeleton coordinate points 605a and 605b indicating the waist. Note that the skeleton-point selection unit 14 can specify the skeleton coordinate points 601 to 605b of the driver 201a on the basis of the information of the seat on which the occupant is seated included in the seat-associated skeleton-coordinate-point information.

The skeleton-point selection unit 14 does not select, as the physique determining skeleton coordinate points, the skeleton coordinate point 603a indicating the right shoulder farther from the image capturing device 2 out of the skeleton coordinate points 603a and 603b indicating the shoulders, the skeleton coordinate point 604a indicating the right elbow farther from the image capturing device 2 out of the skeleton coordinate points 604a and 604b indicating the elbows, and the skeleton coordinate point 605a indicating the right waist farther from the image capturing device 2 out of the skeleton coordinate points 605a and 605b indicating the waist.

Note that the nose and the neck are not paired body parts. Therefore, the skeleton-point selection unit 14 selects the skeleton coordinate points 601 indicating the nose and the skeleton coordinate points 602 indicating the neck as the physique determining skeleton coordinate points without determining whether or not the skeleton coordinate points are closer to the image capturing device 2 as described above.

Similarly, the skeleton-point selection unit 14 selects physique determining skeleton coordinate points among the skeleton coordinate points 606 to 610b of the passenger seat occupant 202a. In the example of FIG. 3, the skeleton-point selection unit 14 selects, as the physique determining skeleton coordinate points of the passenger seat occupant 202a, the skeleton coordinate point 606 indicating the nose, the skeleton coordinate point 607 indicating the neck, the skeleton coordinate point 608a indicating the right shoulder, the skeleton coordinate point 609a indicating the right elbow, and the skeleton coordinate point 610a indicating the right waist.

The skeleton-point selection unit 14 outputs information (hereinafter, referred to as “physique determining skeleton-coordinate-point information”) of the selected physique determining skeleton coordinate points to the feature-amount calculation unit 15. For example, in the physique determining skeleton-coordinate-point information, for each occupant, information specifying the occupant, coordinates of the physique determining skeleton coordinate points of the occupant in the captured image, and information capable of specifying which part of the body the physique determining skeleton coordinate point indicates are associated. Specifically, the information specifying the occupant includes, for example, information indicating the seat on which the occupant is seated.

The feature-amount calculation unit 15 calculates a feature amount (hereinafter, referred to as “physique determining feature amount”) used for determining the physique of the occupant on the basis of the information of the physique determining skeleton coordinate points selected by the skeleton-point selection unit 14, in other words, the physique determining skeleton-coordinate-point information output from the skeleton-point selection unit 14.

For example, on the basis of the physique determining skeleton-coordinate-point information, the feature-amount calculation unit 15 calculates the physique determining feature amount with the length of a line segment connecting two points among the physique determining skeleton coordinate points in the captured image. Specifically, for example, the feature-amount calculation unit 15 calculates, as the physique determining feature amount, the length of the upper arm, the shoulder width, and the length of the neck of the occupant in the captured image on the basis of the physique determining skeleton-coordinate-point information. Note that the feature-amount calculation unit 15 calculates the physique determining feature amount for each occupant.

In the first embodiment, the length of the upper arm of the occupant as the physique determining feature amount is defined as the length of a line segment connecting the physique determining skeleton coordinate point indicating the shoulder and the physique determining skeleton coordinate point indicating the elbow. Note that the length of the upper arm of the occupant is the length of a line segment connecting the physique determining skeleton coordinate point indicating the right shoulder and the physique determining skeleton coordinate point indicating the right elbow in the case of the right upper arm, and is the length of a line segment connecting the physique determining skeleton coordinate point indicating the left shoulder and the physique determining skeleton coordinate point indicating the left elbow in the case of the left upper arm.

In addition, in the first embodiment, the shoulder width of the occupant as the physique determining feature amount is defined as the length of a line segment connecting the physique determining skeleton coordinate point indicating the neck and the physique determining skeleton coordinate point indicating the right shoulder, or as the length of a line segment connecting the physique determining skeleton coordinate point indicating the neck and the physique determining skeleton coordinate point indicating the left shoulder.

Furthermore, in the first embodiment, the length of the neck of the occupant as the physique determining feature amount is defined as the length of a line segment connecting the physique determining skeleton coordinate point indicating the nose and the physique determining skeleton coordinate point indicating the neck.

For example, in the example illustrated in FIG. 3, the feature-amount calculation unit 15 calculates, as the physique determining feature amount of the driver 201a, the length (denoted by (a) in FIG. 3) of a line segment connecting the skeleton coordinate point 603b and the skeleton coordinate point 604b. In addition, the feature-amount calculation unit 15 calculates, as the physique determining feature amount of the driver 201a, the length (denoted by (b) in FIG. 3) of a line segment connecting the skeleton coordinate point 602 and the skeleton coordinate point 603b. Furthermore, the feature-amount calculation unit 15 calculates, as the physique determining feature amount of the driver 201a, the length (denoted by (c) in FIG. 3) of a line segment connecting the skeleton coordinate point 601 and the skeleton coordinate point 602.

Moreover, the feature-amount calculation unit 15 calculates, as the physique determining feature amount of the passenger seat occupant 202a, the length (denoted by (a)′ in FIG. 3) of a line segment connecting the skeleton coordinate point 608a and the skeleton coordinate point 609a. Further, the feature-amount calculation unit 15 calculates, as the physique determining feature amount of the passenger seat occupant 202a, the length (denoted by (b)′ in FIG. 3) of a line segment connecting the skeleton coordinate point 607 and the skeleton coordinate point 608a. Furthermore, the feature-amount calculation unit 15 calculates, as the physique determining feature amount of the passenger seat occupant 202a, the length (denoted by (c)′ in FIG. 3) of a line segment connecting the skeleton coordinate point 606 and the skeleton coordinate point 607.

The skeleton coordinate points 601, 602, 603b, 604b, 606, 607, 608a, and 609a are selected as the physique determining skeleton coordinate points by the skeleton-point selection unit 14. Therefore, the feature-amount calculation unit 15 calculates the physique determining feature amount using the skeleton coordinate points 601, 602, 603b, 604b, 606, 607, 608a, and 609a.

Meanwhile, the skeleton coordinate points 603a, 604a, 608a, and 609b are not selected as the physique determining skeleton coordinate points by the skeleton-point selection unit 14. Therefore, the feature-amount calculation unit 15 does not use the skeleton coordinate points 603a, 604a, 608a, and 609b for calculating the physique determining feature amount.

In FIG. 3, the line segment denoted by (a) is the line segment indicating the length of the upper arm of the driver 201a, and the line segment denoted by (a)′ is the line segment indicating the length of the upper arm of the passenger seat occupant 202a. In FIG. 3, the line segment denoted by (b) is the line segment indicating the shoulder width of the driver 201a, and the line segment denoted by (b)′ is the line segment indicating the shoulder width of the passenger seat occupant 202a. In FIG. 3, the line segment denoted by (c) is the line segment indicating the length of the neck of the driver 201a, and the line segment denoted by (c)′ is the line segment indicating the length of the neck of the passenger seat occupant 202a.

Note that, here, for example, the feature-amount calculation unit 15 calculates the length of the upper arm, the shoulder width, and the length of the neck of the occupant as the physique determining feature amount, but this is merely an example.

For example, the feature-amount calculation unit 15 may calculate the length of the upper body as the physique determining feature amount, in addition to the length of the arm, the shoulder width, and the length of the neck of the occupant. The length of the upper body as the physique determining feature amount is defined as the length of a line segment connecting the physique determining skeleton coordinate point indicating the right shoulder and the skeleton coordinate point indicating the right waist, or as the length of a line segment connecting the physique determining skeleton coordinate point indicating the left shoulder and the physique determining skeleton coordinate point indicating the left waist.

For example, in the example of FIG. 3, the feature-amount calculation unit 15 may calculate, as the physique determining feature amount of the driver 201a, the length of a line segment connecting the skeleton coordinate point 603b selected as the physique determining skeleton coordinate point and the skeleton coordinate point 605b selected as the physique determining skeleton coordinate point. In addition, the feature-amount calculation unit 15 may calculate, as the physique determining feature amount of the passenger seat occupant 202a, the length of a line segment connecting the skeleton coordinate point 608a selected as the physique determining skeleton coordinate point and the skeleton coordinate point 609a selected as the physique determining skeleton coordinate point.

Here, the skeleton coordinate point indicating the waist is less likely to be detected than the skeleton coordinate point indicating the nose, the skeleton coordinate point indicating the neck, the skeleton coordinate point indicating the shoulder, and the skeleton coordinate point indicating the elbow. This is because there is a possibility that luggage or the like is placed near the waist of the occupant. For example, as assumed in the first embodiment, in a case where the image capturing device 2 is installed in the central portion of the instrument panel and captures the driver and the passenger seat occupant from below, there is a possibility that the waist of the occupant is hidden by luggage or the like placed near the waist of the occupant. Then, in the physique determination device 1, the skeleton detection unit 12 may not be able to detect the skeleton coordinate point indicating the waist. If the skeleton coordinate point indicating the waist is not detected, the physique determining feature amount using the physique determining skeleton coordinate point indicating the waist is also not calculated. Therefore, it is preferable not to use the physique determining skeleton coordinate point indicating the waist in the calculation of the physique determining feature amount.

Furthermore, in the first embodiment, the feature-amount calculation unit 15 calculates all the length of the upper arm, the shoulder width, and the length of the neck of the occupant as the physique determining feature amount, but this is merely an example.

It is only required that the feature-amount calculation unit 15 calculates at least one of the length of the upper arm, the shoulder width, or the length of the neck of the occupant as the physique determining feature amount.

Therefore, it is only required that the physique determining skeleton coordinate points selected by the skeleton-point selection unit 14 include the skeleton coordinate point indicating the elbow of the occupant or the skeleton coordinate points indicating the skeleton above the elbow of the occupant in the captured image. Note that the physique determining skeleton coordinate points indicating the skeleton above the elbow of the occupant include, specifically, the physique determining skeleton coordinate point indicating the shoulder (the right shoulder or the left shoulder), the physique determination skeleton coordinate point indicating the neck, and the physique determination skeleton coordinate point indicating the nose.

In the first embodiment, among the skeleton coordinate points indicating the parts of the body, which skeleton coordinate point is used as the physique determining skeleton coordinate point can be appropriately set on the basis of the physique determining feature amount.

The feature-amount calculation unit 15 outputs information (hereinafter, referred to as “feature amount information”) of the calculated physique determining feature amount to the physique determination unit 16. In the feature amount information, information specifying the occupant and the physique determining feature amount are associated with each other for each occupant. Specifically, the information specifying the occupant includes, for example, information indicating the seat on which the occupant is seated.

Here, since the feature-amount calculation unit 15 calculates the length of the upper arm, the shoulder width, and the length of the neck of the occupant as the physique determining feature amount, the feature amount information includes a physique determining feature amount indicating the length of the upper arm of the occupant, a physique determining feature amount indicating the shoulder width, and a physique determining feature amount indicating the length of the neck.

The physique determination unit 16 determines the physique of the occupant on the basis of the physique determining feature amount calculated by the feature-amount calculation unit 15. Note that the physique determination unit 16 determines the physique of each occupant. The physique determination unit 16 can specify the physique determining feature amount of each occupant from the feature amount information.

In the first embodiment, as described above, as an example, the physique of the occupant is defined as any of “infant”, “small”, “standard”, and “large”.

The physique determination unit 16 determines the physique of the occupant by obtaining information of the physique of the occupant using, for example, a learned model in machine learning (hereinafter, referred to as “second machine learning model”).

The second machine learning model is a machine learning model that receives, as an input, the physique determining feature amount and outputs the information of the physique of the occupant. The information of the physique may be, a numerical value indicating the physique such as “0”, “1”, “2”, or “3”, or may be an index (hereinafter, referred to as “physique index”) indicating the degree of the physique. Regarding the numerical values indicating the physique, it is assumed that which value indicates what physique is determined in advance. The physique indicated by the numerical value is determined, such as “0: infant”, “1: small”, “2: standard”, or “3: large”.

The second machine learning model is constructed so as to estimate a result for an input in accordance with training data generated in advance on the basis of a combination of an input and teacher label data, that is, by so-called supervised learning. Here, the second machine learning model performs learning so as to output the information of the physique with respect to the physique determining feature amount in accordance with training data in which the input is the physique determining feature amount and the teacher label is the information of the physique of the occupant.

The second machine learning model is stored in advance in a place that can be referred to by the physique determination unit 16.

The physique determination unit 16 determines the physique of the occupant on the basis of the information of the physique of the occupant obtained on the basis of the second machine learning model.

For example, when the information of the physique of the occupant is a numerical value indicating the physique described above, the physique determination unit 16 determines a physique determined in advance on the basis of the numerical value as the physique of the occupant. Furthermore, for example, when the information of the physique of the occupant is a physique index, the physique determination unit 16 determines the physique based on the index. Specifically, for example, information (hereinafter, referred to as “physique definition information”) indicating which physique index is associated with which physique of “infant”, “small”, “standard”, and “large” is generated in advance and stored in a place that can be referred to by the physique determination unit 16. The physique determination unit 16 determines the physique of the occupant with reference to the physique definition information.

The physique determination unit 16 outputs a physique determination result to the physique-determination-result output unit 17.

In the physique determination result, the information specifying the occupant and the information indicating the physique of the occupant are associated with each other for each occupant. Specifically, the information specifying the occupant includes, for example, information indicating the seat on which the occupant is seated.

The physique-determination-result output unit 17 outputs the physique determination result output from the physique determination unit 16 to the airbag control device 3, the notification device 4, and the display device 5.

Note that, in the first embodiment, the physique determination device 1 outputs the physique determination result to the airbag control device 3, the notification device 4, and the display device 5, but this is merely an example. The physique determination device 1 may output the physique determination result to any of the airbag control device 3, the notification device 4, or the display device 5.

The physique determination device 1 does not need to include the physique-determination-result output unit 17, and the physique determination unit 16 may have the function of the physique-determination-result output unit 17.

An operation of the physique determination device 1 according to the first embodiment will be described.

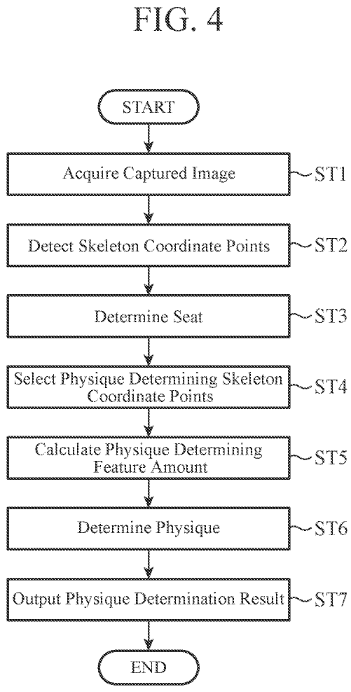

FIG. 4 is a flowchart for explaining the operation of the physique determination device 1 according to the first embodiment.

The captured-image acquisition unit 11 acquires a captured image obtained by capturing an occupant of the vehicle using the image capturing device 2 (step ST1).

The captured-image acquisition unit 11 outputs the acquired captured image to the skeleton detection unit 12.

The skeleton detection unit 12 detects skeleton coordinate points of the occupant indicating the body parts of the occupant on the basis of the captured image acquired by the captured-image acquisition unit 11 in step ST1 (step ST2).

The skeleton detection unit 12 outputs information of the detected skeleton coordinate points to the seating-position determination unit 13.

The seating-position determination unit 13 determines the seating position of the occupant on the basis of the information of the skeleton coordinate points detected by the skeleton detection unit 12 in step ST2. Specifically, the seat on which the occupant is seated is determined on the basis of the information of the skeleton coordinate points detected by the skeleton detection unit 12 in step ST2 (step ST3).

Then, the seating-position determination unit 13 associates the information of the skeleton coordinate points of the occupant output from the skeleton detection unit 12 with the information of the seat on which the occupant is seated.

The seating-position determination unit 13 outputs the seat-associated skeleton-coordinate-point information to the skeleton-point selection unit 14.

The skeleton-point selection unit 14 selects physique determining skeleton coordinate points from the skeleton coordinate points of the occupant detected by the skeleton detection unit 12 in step ST2 on the basis of the seat-associated skeleton-coordinate-point information output from the seating-position determination unit 13 in step ST3. At this time, in a case where the skeleton coordinate points of the occupant detected by the skeleton detection unit 12 are skeleton coordinate points indicating paired body parts, the skeleton-point selection unit 14 selects the physique determining skeleton coordinate points by using the skeleton coordinate points closer to the image capturing device 2 (step ST4).

The skeleton-point selection unit 14 outputs the physique determining skeleton-coordinate-point information to the feature-amount calculation unit 15.

The feature-amount calculation unit 15 calculates the physique determining feature amount on the basis of the information of the physique determining skeleton coordinate points selected by the skeleton-point selection unit 14 in step ST4, in other words, the physique determining skeleton-coordinate-point information output from the skeleton-point selection unit 14 in step ST4 (step ST5).

The feature-amount calculation unit 15 outputs the feature amount information to the physique determination unit 16.

The physique determination unit 16 determines the physique of the occupant on the basis of the physique determining feature amount calculated by the feature-amount calculation unit 15 in step ST5 (step ST6).

The physique determination unit 16 outputs a physique determination result to the physique-determination-result output unit 17.

The physique-determination-result output unit 17 outputs the physique determination result output from the physique determination unit 16 in step ST6 to the airbag control device 3, the notification device 4, and the display device 5 (step ST7).

As described above, in a case where the detected skeleton coordinate points of the occupant are skeleton coordinate points indicating paired body parts, the physique determination device 1 selects the physique determining skeleton coordinate points by using the skeleton coordinate points closer to the image capturing device 2. Then, the physique determination device 1 calculates the physique determining feature amount on the basis of the selected physique determining skeleton coordinate points, and determines the physique of the occupant on the basis of the calculated physique determining feature amount.

For example, depending on the installation position of the image capturing device 2, the infrared emission range in a case where the image capturing device 2 is an infrared camera, or the like, there is a case where out of the skeleton coordinate points indicating paired body parts, the skeleton coordinate point farther from the image capturing device 2 is not detected.

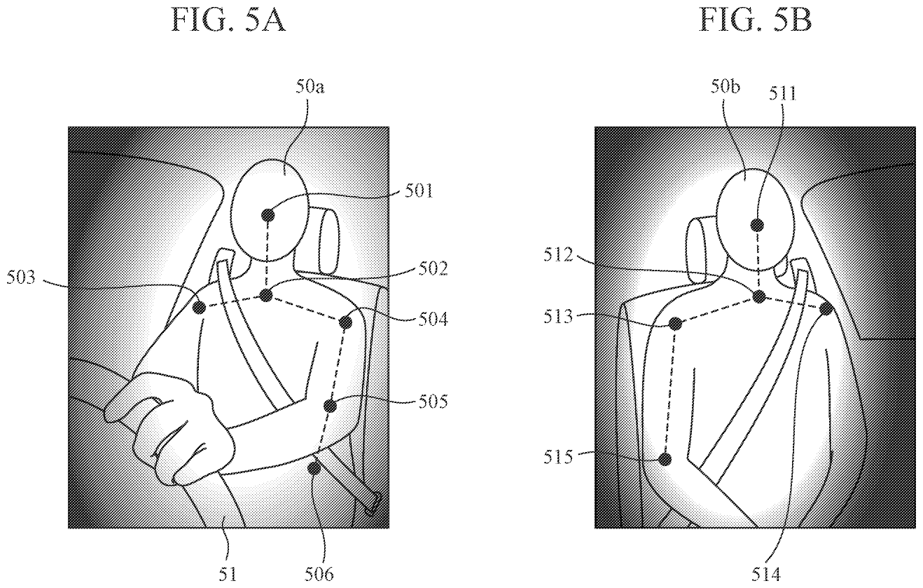

FIGS. 5A and 5B are diagrams for explaining an example of a captured image in a case where the skeleton coordinate point farther from the image capturing device 2 is not detected.

For the sake of convenience, in the example of the captured image illustrated in FIG. 5A, only a portion in which the driver is captured is illustrated, and in the example of the captured image illustrated in FIG. 5B, only a portion in which the passenger seat occupant is captured is illustrated. Furthermore, the image capturing device 2 is assumed to be an infrared camera, and the image capturing device 2 is assumed to be installed at a position where the occupants are captured from below.

In FIG. 5A, 50a denotes a driver, and 51 denotes a steering wheel. Furthermore, in FIG. 5B, 50b denotes a passenger seat occupant. Note that the vehicle 100 is a right-hand drive vehicle.

For example, when detecting the skeleton coordinate points on the basis of the captured image illustrated in FIG. 5A, the skeleton detection unit 12 detects a skeleton coordinate point (denoted by 501 in FIG. 5A) indicating the nose of the driver 50a, a skeleton coordinate point (denoted by 502 in FIG. 5A) indicating the neck of the driver 50a, a skeleton coordinate point (denoted by 503 in FIG. 5A) indicating the right shoulder of the driver 50a, a skeleton coordinate point (denoted by 504 in FIG. 5A) indicating the left shoulder of the driver 50a, a skeleton coordinate point (denoted by 505 in FIG. 5A) indicating the left elbow of the driver 50a, and a skeleton coordinate point (denoted by 506 in FIG. 5A) indicating the left waist of the driver 50a. Since the right elbow and the right waist of the driver 50a are hidden by the steering wheel or the hand of the driver holding the steering wheel, the skeleton detection unit 12 cannot detect the skeleton coordinate point indicating the right elbow of the driver 50a and the skeleton coordinate point indicating the right waist of the driver 50a. The skeleton detection unit 12 may not be able to detect the skeleton coordinate point indicating the right shoulder of the driver 50a because it is hidden by a seat belt (not illustrated).

In addition, for example, when detecting the skeleton coordinate points on the basis of the captured image illustrated in FIG. 5B, the skeleton detection unit 12 detects a skeleton coordinate point (denoted by 511 in FIG. 5B) indicating the nose of the passenger seat occupant 50b, a skeleton coordinate point (denoted by 512 in FIG. 5B) indicating the neck of the passenger seat occupant 50b, a skeleton coordinate point (denoted by 513 in FIG. 5B) indicating the right shoulder of the passenger seat occupant 50b, a skeleton coordinate point (denoted by 514 in FIG. 5B) indicating the left shoulder of the passenger seat occupant 50b, and a skeleton coordinate point (denoted by 515 in FIG. 5B) indicating the right elbow of the passenger seat occupant 50b.

Since the infrared light is not emitted, the skeleton detection unit 12 cannot detect the skeleton coordinate point indicating the left elbow of the passenger seat occupant 50b and the skeleton coordinate points indicating the right and left waists of the passenger seat occupant 50b. As described above, in a case where the image capturing device 2 is an infrared camera, the performance of detecting skeleton coordinate points outside the infrared emission range is lowered.

Therefore, if it is attempted to determine the physique of the occupant using the conventional technique described above, depending on the installation position of the image capturing device, the infrared emission range in a case where the image capturing device is an infrared camera, or the like, it may be impossible to detect the joint point of the shoulder of the occupant farther from the image capturing device 2 or the joint point of the waist of the occupant farther from the image capturing device 2, and as a result, there is a possibility that the physique of the occupant cannot be determined.

In contrast, in a case where the detected skeleton coordinate points of the occupant are skeleton coordinate points indicating paired body parts, as described above, the physique determination device 1 according to the first embodiment selects the physique determining skeleton coordinate points by using the skeleton coordinate points closer to the image capturing device 2. Then, the physique determination device 1 calculates the physique determining feature amount on the basis of the selected physique determining skeleton coordinate points, and determines the physique of the occupant on the basis of the calculated physique determining feature amount. As a result, the physique determination device 1 can improve the accuracy of physique determination as compared with a conventional technique in which physique determination is performed by detecting the joint points of the shoulders and the waists of the occupant.

Note that, as another method of determining the physique of the occupant, for example, a method of determining the physique of the occupant on the basis of the height of the face detected on the basis of a captured image obtained by capturing the occupant is conceivable.

However, in this method, for example, in a case where the occupant moves a seat lifter up and down, or in a case where the occupant is a child seated on a child seat, the physique of the occupant cannot be determined accurately.

As described above, the physique determination device 1 according to the first embodiment determines the physique of the occupant on the basis of the physique determining feature amount calculated on the basis of the selected physique determining skeleton coordinate points. The physique determination device 1 does not use the height of the face of the occupant in order to determine the physique of the occupant. Therefore, the physique determination device 1 can determine the physique of the occupant without being affected by the occupant moving the seat lifter up and down or the occupant being a child seated on a child seat.

In the first embodiment described above, in the case where the occupant is the driver, in other words, in a case where the seat on which the occupant is seated is the driver seat, the physique determination device 1 can also determine the physique of the driver in consideration of the depth distance from the image capturing device 2 to the occupant (that is, the driver).

Specifically, in the physique determination device 1, in a case where the seating-position determination unit 13 determines that the seat on which the occupant is seated is the driver seat, the physique determination unit 16 determines the physique of the driver on the basis of the physique determining feature amount calculated by the feature-amount calculation unit 15 and the information indicating the depth distance from the image capturing device 2 to the driver. For example, the information indicating the depth distance from the image capturing device 2 to the driver is defined as the moving direction of the skeleton coordinate point indicating the neck of the driver in the captured image.

In general, when the driver sits on the driver seat, the driver adjusts the position of the driver seat back and forth on the basis of the physique of the driver so as to facilitate driving. For example, when the physique of the driver is small, the driver moves the driver seat forward, and when the physique of the driver is large, the driver moves the driver seat backward. When the driver seat is moved forward, the skeleton coordinate point indicating the neck of the driver in the captured image moves in the left direction. Conversely, when the driver seat is moved backward, the skeleton coordinate point indicating the neck of the driver in the captured image moves in the right direction. Note that, as described above, the image capturing device 2 is assumed to capture the front seats including the driver seat and the passenger seat from the center of the instrument panel. That is, the image capturing device 2 captures the occupants from the front in the vehicle 100.

For example, in a case where the skeleton coordinate point indicating the neck of the driver moves in the left direction in the captured image, the physique determination unit 16 determines that the driver is likely to be small, decreases the physique index, and then determines the physique of the driver on the basis of the physique index.

Furthermore, for example, the physique determination unit 16 may obtain information of the physique of the driver by inputting the physique determining feature amount calculated by the feature-amount calculation unit 15 and information indicating the moving direction of the skeleton coordinate point indicating the neck of the driver in the captured image to a machine learning model (hereinafter, referred to as “third machine learning model”). The third machine learning model is a machine learning model that receives, as inputs, the physique determining feature amount and the information indicating the moving direction of the skeleton coordinate point indicating the neck of the driver in the captured image, and outputs the information of the physique of the driver.

Note that, for example, in the physique determination device 1, when the engine of the vehicle 100 is turned on, the skeleton detection unit 12 detects skeleton coordinate points on the basis of the captured image, and when the seating-position determination unit 13 determines the seat on which the occupant is seated, the seating-position determination unit stores the seat-associated skeleton-coordinate-point information for a predetermined period. The physique determination unit 16 is only required to determine whether or not the skeleton coordinate point indicating the neck of the driver has moved in the captured image on the basis of the seat-associated skeleton-coordinate-point information stored by the seating-position determination unit 13.

Furthermore, for example, the physique determination unit 16 may obtain the information of the physique of the driver by inputting the physique determining feature amount calculated by the feature-amount calculation unit 15 and the X coordinate of the skeleton coordinate point indicating the neck of the driver in the captured image to a machine learning model (hereinafter, referred to as “fourth machine learning model”). The fourth machine learning model is a machine learning model that receives, as inputs, the physique determining feature amount and the X coordinate of the skeleton coordinate point indicating the neck of the driver in the captured image and outputs the information of the physique of the driver.

When determining the physique of the driver using the fourth machine learning model, the physique determination unit 16 can determine the physique of the driver in consideration of the depth distance from the image capturing device 2 to the driver on the basis of one captured image captured by the image capturing device 2 while the image capturing device 2 captures the occupant.

Furthermore, for example, the information indicating the depth distance from the image capturing device 2 to the driver may be information of the width of the driver's eyes.

For example, in a case where the driver is small and moves the driver seat forward, the width of the driver's eyes increases. Conversely, in a case where the driver is large and moves the driver seat backward, the width of the driver's eyes decreases. Note that the width of human eyes is said to be substantially equal regardless of the physique.

For example, in a case where the width of the driver's eyes increases in the captured image, the physique determination unit 16 determines that the driver is likely to be small, decreases the physique index, and then determines the physique of the driver on the basis of the physique index.

Furthermore, for example, the physique determination unit 16 may obtain the information of the physique of the driver by inputting the physique determining feature amount calculated by the feature-amount calculation unit 15 and information indicating the degree of the change in the width of the driver's eyes in the captured image to a machine learning model (hereinafter, referred to as “fifth machine learning model”). The fifth machine learning model is a machine learning model that receives, as inputs, the physique determining feature amount and the information indicating the degree of the change in the width of the driver's eyes in the captured image, and outputs the information of the physique of the driver.

For example, when the engine of the vehicle 100 is turned on, the physique determination unit 16 acquires a captured image from the captured-image acquisition unit 11, performs a known image recognition process on the captured image, and calculates the width of the driver's eyes. The physique determination unit 16 stores the information of the calculated width of the driver's eyes for a predetermined period. Then, the physique determination unit 16 is only required to determine the degree of the change in the width of the driver's eyes in the captured image on the basis of the stored information of the width of the driver's eyes.

Furthermore, for example, the physique determination unit 16 may obtain the information of the physique of the driver by inputting the physique determining feature amount calculated by the feature-amount calculation unit 15 and the information of the width of the driver's eye in the captured image to a machine learning model (hereinafter, referred to as “sixth machine learning model”). The sixth machine learning model is a machine learning model that receives, as inputs, the physique determining feature amount and the information of the width of the driver's eyes in the captured image, and outputs the information of the physique of the driver.

When determining the physique of the driver using the sixth machine learning model, the physique determination unit 16 can determine the physique of the driver in consideration of the depth distance from the image capturing device 2 to the driver on the basis of one captured image captured by the image capturing device 2 while the image capturing device 2 captures the occupant.

As described above, in a case where the occupant is the driver, the physique determination device 1 can determine the physique of the driver in consideration of the depth distance from the image capturing device 2 to the driver. As a result, the physique determination device 1 can improve the accuracy of determining the physique of the driver as compared with the case of determining the physique of the driver without considering the depth distance.

Furthermore, in the first embodiment described above, the physique determination device 1 may determine whether or not the seating state of the occupant is a normal seating state, and determine the physique of the occupant when determining that the seating state of the occupant is the normal seating state.

Specifically, in the physique determination device 1, the physique determination unit 16 determines whether or not the seating state of the occupant is the normal seating state on the basis of the skeleton coordinate points detected by the skeleton detection unit 12, and determines the physique of the occupant when determining that the seating state of the occupant is the normal seating state.

In the first embodiment, the state where the occupant is in the normally seating state means that the posture of the occupant is a posture in which the physique of the occupant can be appropriately determined. In a case where the posture of the occupant is a posture in which the physique of the occupant cannot be appropriately determined, it is determined that the occupant is not in the normal seating state. Specifically, the posture in which the physique of the occupant cannot be appropriately determined means, for example, a state where the posture of the occupant is lost. Furthermore, the posture in which the physique of the occupant cannot be appropriately determined means, for example, a posture in which the occupant greatly extends his/her hand in the direction of the image capturing device 2.

For example, the physique determination unit 16 determines whether or not the seating state of the occupant is the normal seating state by comparing the physique determining feature amounts calculated by the feature-amount calculation unit 15. The physique determining feature amount is calculated on the basis of the physique determining skeleton coordinate points detected by the skeleton detection unit 12 and selected by the skeleton-point selection unit 14.

As a specific example, the physique determination unit 16 compares the physique determining feature amount indicating the length of the upper arm of the occupant, the physique determining feature amount indicating the shoulder width of the occupant, and the physique determining feature amount indicating the length of the neck of the occupant, and determines whether or not there is an extremely small physique determining feature amount. In a case where there is an extremely small physique determining feature amount, the physique determination unit 16 determines that the occupant is not in the normal sitting state. For example, in a case where the occupant extends the hand to a great extent in the direction of the image capturing device 2, the physique determining skeleton coordinate point indicating the shoulder of the occupant and the physique determining skeleton coordinate point indicating the elbow of the occupant are close to each other in the captured image. That is, the physique determining feature amount indicating the upper arm of the occupant is extremely smaller than the physique determining feature amount indicating the shoulder width of the occupant and the physique determining feature amount indicating the length of the neck of the occupant. In this case, the physique determining feature amount indicating the upper arm of the occupant is not appropriately calculated, and the physique of the occupant cannot be appropriately determined when using the physique determining feature amount. Therefore, in a case where there is an extremely small physique determining feature amount, the physique determination unit 16 determines that the occupant is not in the normal sitting state.

The physique determination unit 16 compares the physique determining feature amount indicating the length of the upper arm of the occupant, the physique determining feature amount indicating the shoulder width of the occupant, and the physique determining feature amount indicating the length of the neck of the occupant, and determines that the occupant is in the normal sitting state when there is no extremely small physique determining feature amount.

For example, the physique determination unit 16 may determine whether or not the seating state of the occupant is the normal seating state on the basis of the inclination of a line segment connecting two skeleton coordinate points in the captured image.

As a specific example, for example, the physique determination unit 16 calculates the inclination of a line segment connecting the skeleton coordinate point indicating the neck of the occupant and the skeleton coordinate point indicating either the right or left waist of the occupant. Then, the physique determination unit 16 compares the calculated inclination of the line segment with an inclination stored in advance (hereinafter, referred to as “normal-seating determining inclination”) for determining whether or not the occupant is in the normal seating state, and determines that the occupant is in the normal seating state when the difference between the calculated inclination of the line segment and the normal-seating determining inclination is within a predetermined threshold (hereinafter, referred to as “normal-seating determining threshold”). The normal-seating determining inclination is defined as, for example, the inclination of a line segment connecting a skeleton coordinate point indicating the neck of a person and a skeleton coordinate point indicating either the left or right waist of the person in a state where the person with a standard physique is seated at a standard position without losing his/her posture. The normal-seating determining inclination is set in advance and stored in the physique determination unit 16.

On the other hand, in a case where the difference between the calculated inclination of the line segment and the normal-seating determining inclination is larger than the normal-seating determining threshold, the physique determination unit 16 determines that the occupant is not in the normal seating state. In a case where the difference between the calculated inclination of the line segment and the normal-seating determining inclination is larger than the normal-seating determining threshold, it is assumed that the posture of the occupant is lost.

When determining that the occupant is in the normal sitting state, the physique determination unit 16 determines the physique of the occupant determined to be in the normal sitting state. When determining that the occupant is not in the normal sitting state, the physique determination unit 16 does not determine the physique of the occupant determined to be not in the normal sitting state.

Note that the physique determination unit 16 determines whether or not each occupant is in the normal sitting state.

In the description, it has been described that, in the physique determination device 1, the physique determination unit 16 determines the physique of the occupant determined to be in the normal sitting state when determining that the seating state of the occupant is the normal sitting state, and does not determine the physique of the occupant determined to be not in the normal sitting state when determining that the seating state of the occupant is not the normal sitting state, but this is merely an example.

For example, in the physique determination device 1, even in a situation in which the seating position of the occupant is assumed to be not in the normal sitting state, the physique determination unit 16 may select the physique determining feature amount used to determine the physique of the occupant on the basis of the relationship between the physique determining feature amounts, and then determine the physique of the occupant using the selected physique determining feature amount.

Specifically, for example, as in the example described above, it is assumed that the occupant greatly extends the hand in the direction of the image capturing device 2, and the physique determining feature amount indicating the upper arm of the occupant is extremely smaller than the physique determining feature amount indicating the shoulder width of the occupant and the physique determining feature amount indicating the length of the neck of the occupant. In this case, the physique determination unit 16 excludes an extremely small physique determining feature amount indicating the length of the upper arm of the occupant, and selects the physique determining feature amount indicating the shoulder width of the occupant and the physique determining feature amount indicating the length of the neck of the occupant as the physique determining feature amounts used to determine the physique of the occupant. Then, the physique determination unit 16 determines the physique of the occupant on the basis of the physique determining feature amount indicating the shoulder width of the occupant and the physique determining feature amount indicating the length of the neck of the occupant.

Furthermore, it is not limited to the example described above, and for example, due to erroneous detection of skeleton coordinate points of the occupant by the skeleton detection unit 12, a certain physique determining feature amount may be extremely smaller or extremely larger than other physique determining feature amounts.

As a specific example, for example, it is assumed that the skeleton detection unit 12 erroneously detects a skeleton coordinate point indicating the elbow of the occupant. Note that it is assumed that the skeleton detection unit 12 can appropriately detect skeleton coordinate points other than that of the elbow of the occupant. In this case, the feature-amount calculation unit 15 may not be able to appropriately calculate the physique determining feature amount indicating the upper arm of the occupant. For example, there is a possibility that the feature-amount calculation unit 15 calculates the physique determining feature amount indicating the upper arm of the occupant to be extremely smaller or extremely larger than other physique determining feature amounts (the physique determining feature amount indicating the shoulder width of the occupant and the physique determining feature amount indicating the length of the neck of the occupant). Then, the physique determination unit 16 determines that the seating state of the occupant is not the normal seating state.

Also in such a case, for example, if the physique determination unit 16 determines that the seating state of the occupant is not the normal sitting state, the physique determination unit does not determine the physique of the occupant determined to be not in the normal sitting state.

Moreover, the physique determination unit 16 may exclude an extremely small or extremely large physique determining feature amount indicating the upper arm of the occupant, select the physique determining feature amount indicating the shoulder width of the occupant and the physique determining feature amount indicating the length of the neck of the occupant as the physique determining feature amount used to determine the physique of the occupant, and determine the physique of the occupant.

As described above, in the first embodiment, the physique determination device 1 may determine whether or not the seating state of the occupant is the normal seating state, and determine the physique of the occupant when determining that the seating state of the occupant is the normal seating state. As a result, the physique determination device 1 can reduce erroneous determination of the physique of the occupant in a case where the posture of the occupant is lost or the like.

Furthermore, in the first embodiment, the physique determination device 1 may select the physique determining feature amount used to determine the physique of the occupant on the basis of the relationship between the physique determining feature amounts, and then determine the physique of the occupant using the selected physique determining feature amount. As a result, the physique determination device 1 can prevent, for example, a decrease in the performance of the physique determination due to the posture of the occupant or a decrease in the performance of the physique determination due to the presence of skeleton coordinate points that have not been appropriately detected.

Moreover, in the first embodiment described above, the skeleton coordinate point detected by the skeleton detection unit 12 of the physique determination device 1 is, for example, a point in a captured image and is represented by coordinates in the captured image, but this is merely an example.

In the first embodiment described above, the skeleton detection unit 12 can also detect the skeleton coordinate point of the occupant as three-dimensional coordinates in the space within the image capturing range of the image capturing device 2. In this case, the feature-amount calculation unit 15 calculates the length of the upper arm, the shoulder width, or the length of the neck of the occupant as a three-dimensional distance.

Specifically, for example, the skeleton detection unit 12 obtains information of the skeleton coordinate point using, for example, a learned model in machine learning (hereinafter, referred to as “seventh machine learning model”) that receives a captured image as an input and outputs the information of the skeleton coordinate point. The information of the skeleton coordinate point output from the seventh machine learning model includes information of the skeleton coordinate point in the captured image indicated by the three-dimensional coordinates and information capable of specifying which part of the body the skeleton coordinate point indicates.

The seventh machine learning model is constructed in accordance with training data generated in advance, that is, by so-called supervised learning. The seventh machine learning model performs learning so as to output the information of the skeleton coordinate point in the captured image in accordance with training data in which the input is the captured image and the teacher label is the information of the skeleton coordinate point acquired by motion capture or the like and indicated by three-dimensional coordinates.

The seventh machine learning model is stored in advance in a place that can be referred to by the skeleton detection unit 12. Note that the seventh machine learning model performs learning so as to output information of a plurality of skeleton coordinate points in the captured image.

Moreover, the image capturing device 2 is installed at the center of the instrument panel in the first embodiment described above, but this is merely an example.

For example, the image capturing device 2 may be provided in an A-pillar on the driver seat side or the passenger seat side, may be provided in a dashboard, or may be provided in an audio control panel. Furthermore, the image capturing device 2 may be provided in a rearview mirror.

The image capturing device 2 is only required to be installed to be able to capture at least a range in the vehicle 100 including a range in which the upper body of the occupant in the vehicle 100 is to be present.

Furthermore, it is assumed that there is one image capturing device 2 in the first embodiment described above, but this is merely an example. In the first embodiment, a plurality of image capturing devices 2 may be installed in the vehicle 100.

For example, the plurality of image capturing devices 2 may be installed so as to be able to capture occupants seated on the individual seats in the vehicle 100. In this case, the physique determination device 1 acquires captured images from the plurality of image capturing devices 2 and determines the physique of each of the occupants.

Moreover, in the first embodiment described above, in a case where the skeleton coordinate points indicating paired body parts are at the same distance from the image capturing device 2 when selecting the physique determining skeleton coordinate points, the skeleton-point selection unit 14 of the physique determination device 1 may use any skeleton coordinate point of the skeleton coordinate points indicating paired body parts as the physique determining skeleton coordinate point.

For example, in a case where the image capturing device 2 captures the occupant from right in front in such a manner that the optical axis of the image capturing device 2 passes through the center of the occupant, the distance between the image capturing device 2 and the skeleton coordinate point indicating the left shoulder and the distance between the image capturing device 2 and the skeleton coordinate point indicating the right shoulder may be equal. In this case, the skeleton-point selection unit 14 is only required to use either the skeleton coordinate point indicating the left shoulder or the skeleton coordinate point indicating the right shoulder as the physique determining skeleton coordinate point.

Note that in a case where there are a plurality of sets of skeleton coordinate points with the same distance from the image capturing device 2 among the skeleton coordinate points indicating paired body parts, the skeleton-point selection unit 14 makes a selection in such a manner that among the sets of the left and right skeleton coordinate points in the captured image, the skeleton coordinate points on the same side are used as the physique determining skeleton coordinate points.

Furthermore, in the first embodiment described above, in a case where the number of occupants whose physique is to be determined by the physique determination device 1 is determined as one, for example, only the driver among the occupants of the vehicle 100 is determined to be subjected to physique determination by the physique determination device, the skeleton-point selection unit 14 can use, as the physique determining skeleton coordinate point, a skeleton coordinate point closer to the image capturing device 2 of the skeleton coordinate points indicating paired body parts, regardless of the seat on which the occupant is seated.

For example, even in a case where the image capturing device 2 is installed for each occupant, the skeleton-point selection unit 14 can use, as the physique determining skeleton coordinate point, a skeleton coordinate point closer to the image capturing device 2 of the skeleton coordinate points indicating paired body parts, regardless of the seat on which the occupant is seated.

In this case, the physique determination device 1 does not necessarily include the seating-position determination unit 13. In a case where the skeleton coordinate points of the occupant are skeleton coordinate points indicating paired body parts, on the basis of the information of the skeleton coordinate points output from the skeleton detection unit 12, the skeleton-point selection unit 14 is only required to select the physique determining skeleton coordinate points from the skeleton coordinate points of the occupant detected by the skeleton detection unit 12 by using the skeleton coordinate points closer to the image capturing device 2.

Note that, for example, even in a case where the number of occupants whose physique is to be determined by the physique determination device 1 is determined as one, or even in a case where the image capturing device 2 is installed for each occupant, the seating-position determination unit 13 may determine the seat on which the occupant is seated, and the skeleton-point selection unit 14 may select the physique determining skeleton coordinate point on the basis of the seat-associated skeleton-coordinate-point information.

Furthermore, it is assumed in the first embodiment described above that the image capturing device 2 captures the driver seat and the passenger seat, but this is merely an example. The image capturing device 2 can also be installed so as to be able to capture the back seat, and the physique determination device 1 can also determine the physique of the occupant in the back seat on the basis of a captured image obtained by capturing the back seat using the image capturing device 2.

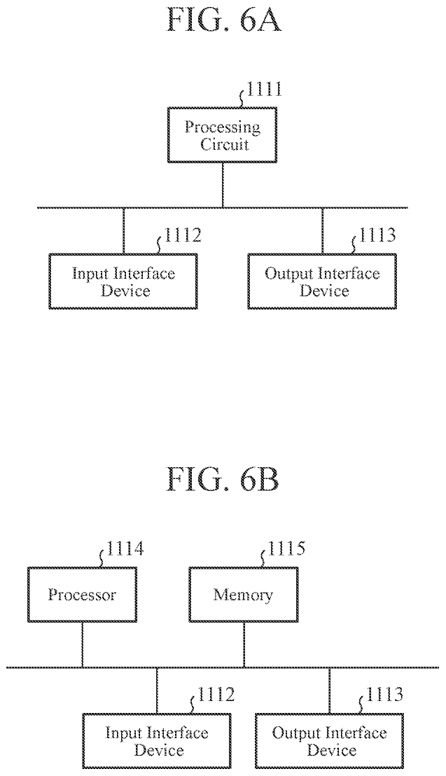

FIGS. 6A and 6B are diagrams illustrating an example of a hardware configuration of the physique determination device 1 according to the first embodiment.

In the first embodiment, the functions of the captured-image acquisition unit 11, the skeleton detection unit 12, the seating-position determination unit 13, the skeleton-point selection unit 14, the feature-amount calculation unit 15, the physique determination unit 16, and the physique-determination-result output unit 17 are implemented by a processing circuit 1111. That is, the physique determination device 1 includes the processing circuit 1111 for executing control to determine the physique of the occupant on the basis of a captured image obtained by capturing the occupant of the vehicle 100.

The processing circuit 1111 may be dedicated hardware illustrated in FIG. 6A, or may be a processor 1114 that executes a program stored in a memory, as illustrated in FIG. 6B.

In a case where the processing circuit 1111 is dedicated hardware, the processing circuit 1111 corresponds to, for example, a single circuit, a composite circuit, a programmed processor, a parallel programmed processor, an application specific integrated circuit (ASIC), a field-programmable gate array (FPGA), or a combination thereof.

In a case where the processing circuit is the processor 1114, the functions of the captured-image acquisition unit 11, the skeleton detection unit 12, the seating-position determination unit 13, the skeleton-point selection unit 14, the feature-amount calculation unit 15, the physique determination unit 16, and the physique-determination-result output unit 17 are implemented by software, firmware, or a combination of software and firmware. The software or firmware is described as a program and stored in a memory 1115. The processor 1114 reads and executes the program stored in the memory 1115, thereby performing the functions of the captured-image acquisition unit 11, the skeleton detection unit 12, the seating-position determination unit 13, the skeleton-point selection unit 14, the feature-amount calculation unit 15, the physique determination unit 16, and the physique-determination-result output unit 17. That is, the physique determination device 1 includes the memory 1115 for storing a program that results in steps ST1 to ST7 in FIG. 4 being performed when executed by the processor 1114. It can also be said that the program stored in the memory 1115 causes a computer to perform the procedures or methods implemented by the captured-image acquisition unit 11, the skeleton detection unit 12, the seating-position determination unit 13, the skeleton-point selection unit 14, the feature-amount calculation unit 15, the physique determination unit 16, and the physique-determination-result output unit 17. Here, the memory 1115 corresponds to, a nonvolatile or volatile semiconductor memory such as a RAM, a read only memory (ROM), a flash memory, an erasable programmable read only memory (EPROM), or an electrically erasable programmable read only memory (EEPROM), a magnetic disk, a flexible disk, an optical disk, a compact disk, a mini disk, a digital versatile disc (DVD), or the like.

Note that some of the functions of the captured-image acquisition unit 11, the skeleton detection unit 12, the seating-position determination unit 13, the skeleton-point selection unit 14, the feature-amount calculation unit 15, the physique determination unit 16, and the physique-determination-result output unit 17 may be implemented by dedicated hardware, and some thereof may be implemented by software or firmware. For example, the functions of the captured-image acquisition unit 11 and the skeleton detection unit 12 can be implemented by the processing circuit 1111 as dedicated hardware, and the functions of the seating-position determination unit 13, the skeleton-point selection unit 14, the feature-amount calculation unit 15, the physique determination unit 16, and the physique-determination-result output unit 17 can be implemented by the processor 1114 reading and executing programs stored in the memory 1115.

In addition, the physique determination device 1 includes an input interface device 1112 and an output interface device 1113 that perform wired communication or wireless communication with a device such as the image capturing device 2, the airbag control device 3, the notification device 4, or the display device 5.

In the first embodiment described above, the physique determination device 1 is an in-vehicle device mounted on the vehicle 100, and the captured-image acquisition unit 11, the skeleton detection unit 12, the seating-position determination unit 13, the skeleton-point selection unit 14, the feature-amount calculation unit 15, the physique determination unit 16, and the physique-determination-result output unit 17 are included in the physique determination device 1.

It is not limited thereto, and some of the captured-image acquisition unit 11, the skeleton detection unit 12, the seating-position determination unit 13, the skeleton-point selection unit 14, the feature-amount calculation unit 15, the physique determination unit 16, and the physique-determination-result output unit 17 may be mounted on the in-vehicle device of the vehicle, and the remaining may be provided in a server connected to the in-vehicle device via a network, so that the in-vehicle device and the server may constitute a physique determination system.

In addition, all of the captured-image acquisition unit 11, the skeleton detection unit 12, the seating-position determination unit 13, the skeleton-point selection unit 14, the feature-amount calculation unit 15, the physique determination unit 16, and the physique-determination-result output unit 17 may be provided in the server.

As described above, according to the first embodiment, the physique determination device 1 includes the skeleton detection unit 12 to detect a skeleton coordinate point of an occupant indicating a body part of the occupant on the basis of a captured image obtained by capturing the occupant of the vehicle 100 using the image capturing device 2, the skeleton-point selection unit 14 to, in a case where skeleton coordinate points of the occupant detected by the skeleton detection unit 12 are skeleton coordinate points indicating paired body parts, select a physique determining skeleton coordinate point from the skeleton coordinate points of the occupant detected by the skeleton detection unit 12 by using the skeleton coordinate point closer to the image capturing device 2, the feature-amount calculation unit 15 to calculate a physique determining feature amount on the basis of information of the physique determining skeleton coordinate point selected by the skeleton-point selection unit 14, and the physique determination unit 16 to determine the physique of the occupant on the basis of the physique determining feature amount calculated by the feature-amount calculation unit 15. Therefore, the physique determination device 1 can improve the accuracy of physique determination as compared with a conventional technique in which physique determination is performed by detecting the joint points of the shoulders and the waists of the occupant.

Furthermore, according to the first embodiment, the physique determination device 1 includes the seating-position determination unit 13 to determine a seat on which the occupant is seated on the basis of information of the skeleton coordinate points of the occupant detected by the skeleton detection unit 12, and associate the information of the skeleton coordinate points of the occupant with information of the seat on which the occupant is seated. The skeleton-point selection unit 14 selects the physique determining skeleton coordinate point from the skeleton coordinate points of the occupant detected by the skeleton detection unit 12 by using the skeleton coordinate point closer to the image capturing device 2 in a case where the skeleton coordinate points of the occupant detected by the skeleton detection unit 12 are the skeleton coordinate points indicating paired body parts on the basis of the information of the skeleton coordinate points of the occupant and the information of the seat on which the occupant is seated, associated by the seating-position determination unit 13. Therefore, even in a case where the image capturing device 2 captures a plurality of occupants, the physique determination device 1 can determine the physique of each of the occupants.

Note that it is possible to modify or omit any component of the embodiment in the present disclosure.

### INDUSTRIAL APPLICABILITY

The physique determination device according to the present disclosure can improve the accuracy of physique determination as compared with a conventional technique in which physique determination is performed by detecting joint points of the shoulders and the waists of the occupant.

### REFERENCE SIGNS LIST

1: physique determination device, 11: captured-image acquisition unit, 12: skeleton detection unit, 13: seating-position determination unit, 14: skeleton-point selection unit, 15: feature-amount calculation unit, 16: physique determination unit, 17: physique-determination-result output unit, 2: image capturing device, 3: airbag control device, 4: notification device, 5: display device, 6: seat belt control device, 100: vehicle, 1111: processing circuit, 1112: input interface device, 1113: output interface device, 1114: processor, 1115: memory

1. A physique determination device comprising:
processing circuitry configured to
detect at least one skeleton coordinate point of an occupant indicating a body part of the occupant on a basis of a captured image obtained by capturing the occupant of a vehicle using an image capturing device, the at least one skeleton coordinate point including a plurality of skeleton coordinate points;
select, in a case where the detected skeleton coordinate points of the occupant indicate paired body parts, a physique determining skeleton coordinate point from the detected skeleton coordinate points of the occupant by using the at least one skeleton coordinate point closer to the image capturing device;
calculate at least one physique determining feature amount on a basis of information of the selected physique determining skeleton coordinate point; and
determine a physique of the occupant on a basis of the at least one physique determining feature amount having been calculated.

2. The physique determination device according to claim 1
wherein the processing circuitry is further configured to
determine a seat on which the occupant is seated on a basis of information of the skeleton coordinate points of the occupant having been detected, and associate the information of the skeleton coordinate points of the occupant with information of the seat on which the occupant is seated, wherein
selects the physique determining skeleton coordinate point from the detected skeleton coordinate points of the occupant by using the at least one skeleton coordinate point closer to the image capturing device in a case where the detected skeleton coordinate points of the occupant indicate paired skeletons, on a basis of the information of the skeleton coordinate points of the occupant and the information of the seat on which the occupant is seated.

3. The physique determination device according to claim 1, wherein
the selected physique determining skeleton coordinate point includes a point indicating an elbow of the occupant or a point indicating a skeleton above the elbow of the occupant in the captured image.

4. The physique determination device according to claim 3, wherein
the processing circuitry calculates at least one of a length of an upper arm, a shoulder width, or a length of a neck of the occupant as the at least one physique determining feature amount.

5. The physique determination device according to claim 1
wherein the processing circuitry is further configured to
determine a seat on which the occupant is seated on a basis of information of the skeleton coordinate points of the occupant having been detected, and associate the information of the skeleton coordinate points of the occupant with information of the seat on which the occupant is seated, wherein
in a case where the processing circuitry determines that the seat on which the occupant is seated is a driver seat, the processing circuitry determines a physique of the occupant on a basis of the at least one physique determining feature amount having been calculated and information indicating a depth distance from the image capturing device to the occupant.

6. The physique determination device according to claim 1, wherein
the processing circuitry determines whether or not a seating state of the occupant is a normal seating on a basis of the selected physique determining skeleton coordinate point, and in a case where it is determined that the seating state of the occupant is the normal seating state, determines a physique of the occupant.

7. The physique determination device according to claim 1, wherein
the at least one physique determining feature amount includes a plurality of physique determining feature amounts, and
the processing circuitry selects the at least one physique determining feature amount used to determine the physique of the occupant on a basis of a relationship between the physique determining feature amounts, and determines the physique of the occupant using a selected physique determining feature amount.

8. The physique determination device according to claim 4, wherein
the processing circuitry detects the at least one skeleton coordinate point of the occupant as three-dimensional coordinates, and
calculates the length of the upper arm, the shoulder width, or the length of the neck of the occupant as a three-dimensional distance.

9. A physique determination method comprising:
detecting at least one skeleton coordinate point of an occupant indicating a body part of the occupant on a basis of a captured image obtained by capturing the occupant of a vehicle using an image capturing device, the at least one skeleton coordinate point including a plurality of skeleton coordinate points;
selecting in a case where the detected skeleton coordinate points of the occupant indicate paired body parts, a physique determining skeleton coordinate point from the skeleton coordinate points of the occupant having been detected by using the at least one skeleton coordinate point closer to the image capturing device;
calculating at least one physique determining feature amount on a basis of information of the selected physique determining skeleton coordinate point; and
determining a physique of the occupant on a basis of the at least one physique determining feature amount having been calculated.
